(19) United States
(12) Patent Application Publication
(10) Pub. No.: US 2018/0203471 A1
(43) Pub. Date: Jul. 19, 2018

(54) CLEARANCE SENSOR SYSTEM

(71) Applicant: Sikorsky Aircraft Corporation, Stratford, CT (US)

(72) Inventors: Jesse J. Lesperance, Jr., Harvest, AL (US); Andrew Gandia, Stratford, CT (US); Thomas R. Zygmant, Southport, CT (US); Nicholas Charles Visinski, Fairfield, CT (US)

(21) Appl. No.: 15/741,683

(22) PCT Filed: May 10, 2016
(86) PCT No.: PCT/US2016/031630

§ 371 Date: Jan. 3, 2018

Related U.S. Application Data
(60) Provisional application No. 62/193,396, filed on Jul. 16, 2015.

(51) Int. Cl. G05D 3/00; B64D 9/00

(52) U.S. Cl. CPC G05D 3/00; G01B 21/16; B64D 9/00

(57) ABSTRACT

A clearance sensor system is provided for use in moving first and second articles and includes a driving element disposed to drive and manipulate the first article relative to the second article, a plurality of sensors arrayed about at least the second article to generate real-time readings of physical separation of the first and second articles and a controller operably coupled to the driving element and the plurality of sensors. The controller is configured to facilitate an execution of real-time or quasi-dynamic control of a driving of the first article by the driving element in accordance with the readings of the physical separation between the first and second articles provided by the plurality of sensors, and a post-processing of data relating to the real-time or quasi-dynamic control of the driving and the manipulation of the first article by the driving element.

### FEDERAL RESEARCH STATEMENT

This invention was made with government support under Navy contract number N00019-08-G-0010. The government has certain rights to this invention.

### BACKGROUND OF THE INVENTION

The subject matter disclosed herein relates to a clearance sensor system and, more particularly, to a controllable clearance sensor system.

In many industries, it is necessary to move large, heavy machinery into spaces with extremely tight clearances. For example, it is often required to transport tanks or helicopters utilizing certain types of cargo planes. Doing so requires that the tank or helicopter be loaded into the cargo plane's cabin through an opening in the fuselage. This opening, at times, is only slightly larger than the cross-section of the tank or helicopter, which drives the need for carefully monitoring the position of the tank or helicopter during the loading operation.

There are very few accurate methods to analyze a loading process for clearance between the cargo's outer mold line (OML) and the cargo plane's inner mold line (IML) prior to actual execution of a load. The shortcoming to these methods is the difficulty in validating their output. For example, monitoring has generally only been conducted by eye sight with ground personnel observing the loading and making positional adjustments to the cargo as necessary. These processes had been iterative processes of trial and error, which could restrict expensive assets from being utilized for long durations at a time. Even if the loading operation was successful without incident, there has been no way to record the completed loading operation for later reference or use the data gleaned from the operation for later reference.

### BRIEF DESCRIPTION OF THE INVENTION

According to one aspect of the invention, a clearance sensor system is provided for use in moving first and second articles relative to each other. The clearance sensor system includes an automatic or manually controlled driving element disposed to drive and manipulate the first article relative to the second article, a plurality of sensors arrayed about at least the second article to generate real-time readings of a position of the first article relative to the second article and a controller operably coupled to the driving element and the plurality of sensors. The controller is configured to facilitate an execution of real-time or quasi-dynamic control of a driving of the first article by the driving element in accordance with the readings of the physical separation between the first and second articles provided by the plurality of sensors and a post-processing of data relating to the real-time or quasi-dynamic control of the driving and the manipulation of the first article by the driving element.

In accordance with additional or alternative embodiments, the first article includes at least a helicopter and the second article includes at least a cargo plane.

In accordance with additional or alternative embodiments, the driving element is disposed to drive and manipulate the first article with multiple degrees of freedom.

In accordance with additional or alternative embodiments, the plurality of sensors includes a plurality of measurement sensors.

In accordance with additional or alternative embodiments, the plurality of sensors includes sensors arrayed at predetermined positions of at least the second article.

In accordance with additional or alternative embodiments, the plurality of sensors includes sensors arrayed at portions of at least the second article associated with tight clearance tolerances.

In accordance with additional or alternative embodiments, the controller includes a computer readable medium having instructions stored thereon, which, when executed, cause the controller to develop a model for the real-time or quasi-dynamic control of the driving and the manipulation for respective pairs of multiple first articles and multiple second articles.

In accordance with additional or alternative embodiments, the controller includes a computer readable medium having instructions stored thereon, which, when executed, cause the controller to store or export data relating to the execution of the real-time or quasi-dynamic control of the driving and the manipulation.

In accordance with additional or alternative embodiments, the controller is further configured to generate and display a user interface to facilitate the real-time or quasi-dynamic control of the driving and the manipulation.

According to yet another aspect of the invention, a controllable clearance sensor system is provided for use in moving first and second articles relative to each other. The controllable clearance sensor system includes an automatic or manually controlled driving element disposed to drive and manipulate the first article relative to the second article, a plurality of sensors arrayed about at least the second article to generate real-time readings of a position of the first article relative to the second article and a controller operably coupled to the driving element and comprising multiple sensor controllers disposed in signal communication with each other and with respective sets of the plurality of sensors. The controller is configured to facilitate an execution of real-time or quasi-dynamic control of a driving and a manipulation of the first article by the driving element in accordance with user input and the readings of the physical separation between the first and second articles provided by the plurality of sensors.

In accordance with additional or alternative embodiments, the controller includes a computer readable medium having instructions stored thereon, which, when executed, cause the controller to facilitate an adjustment of the execution of the real-time or quasi-dynamic control of the driving and the manipulation in accordance with a most-recent set of the readings.

In accordance with additional or alternative embodiments, the controller includes a computer readable medium having instructions stored thereon, which, when executed, cause the controller to import raw data, extract accurate data while expelling erroneous data, align the accurate data to a configured model, filter the aligned data for operator use and permit evaluation.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic side view of a portion of a clearance sensor system;

FIG. 2 is a schematic diagram of another portion of a clearance sensor system;

FIG. 3 is a side view of an operation of the clearance sensor system of FIGS. 1 and 2 in accordance with embodiments;

FIG. 4 is a top-down schematic view of manipulations of a helicopter in accordance with embodiments; and

FIG. 5 is a side schematic view of manipulations of helicopter in accordance with embodiments.

The detailed description explains embodiments of the invention, together with advantages and features, by way of example with reference to the drawings.

### DETAILED DESCRIPTION OF THE INVENTION

As will be described below, an air transport clearance sensor system is provided and includes an architecture of components such as sensors (i.e. laser measuring devices), central controller(s), interface protocols, controller interfaces and controller logic. The architecture enables real-time or quasi-dynamic feedback of physical separation between an item, such as a helicopter, and another item, such as a vehicle the helicopter is being loaded into. This data can be used for immediate use, post processing or fed to other systems.

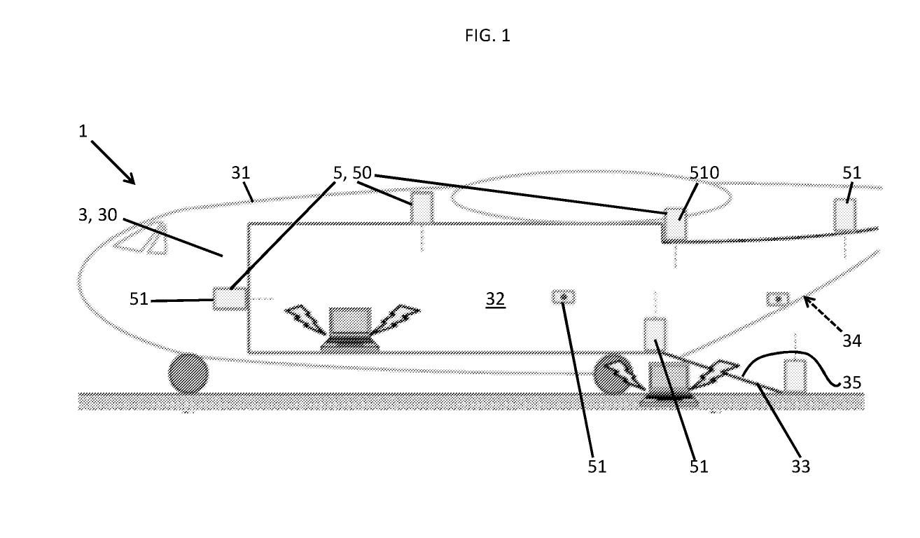

With reference to FIGS. 1-3, a controllable clearance sensor system 1 is provided for use in moving first and second articles 2 and 3 relative to each other. For purposes of clarity and brevity, the following description will relate to the case of the first article 2 being provided as a helicopter 20 and the second article being provided as a transport or cargo plane 30 but it will be understood that this is merely exemplary and that other articles may be substituted to similar effect.

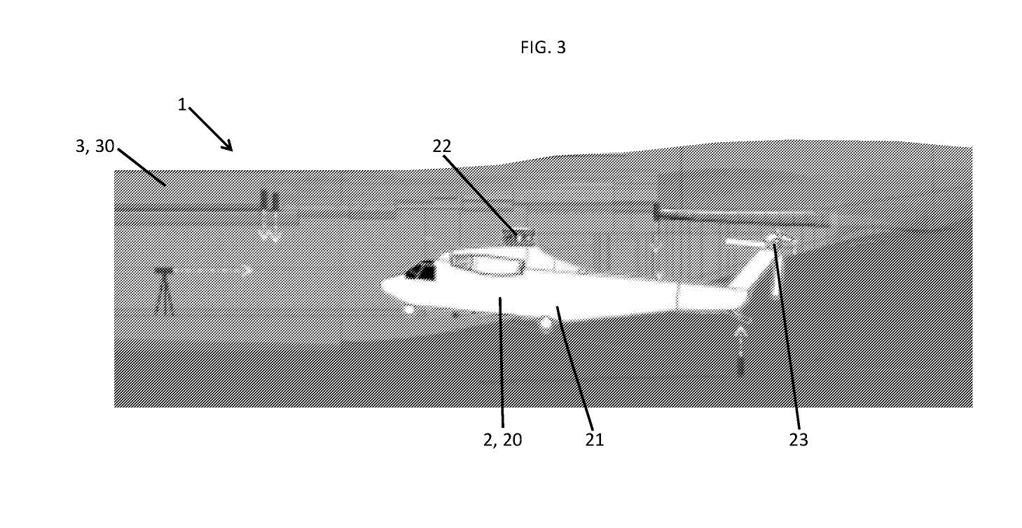

The helicopter 20 includes an airframe 21 having a main section and a tail section, a main rotor 22 disposed at an upper portion of the main section of the airframe 21 and a tail rotor 23 disposed at a distal end of the tail section of the airframe 21. The main rotor 22 and the tail rotor 23 normally include a plurality of blades extending radially outwardly from a hub but in order to fit within the cargo plane 30, those blades may be temporarily removed or folded into a space saving configuration (see FIG. 3).

The cargo plane 30 includes a fuselage 31 that is formed to define a cargo hold 32 therein and a ramp 33. The ramp 33 is pivotable about a hinge from a closed position to an open position. In the closed position, the ramp 33 lies flat on a rear or aft section of the fuselage 31. In the open position, the ramp 33 extends downwardly from the fuselage 31 to the ground and leaves an aperture 34 in the fuselage 3 lopen. The aperture 34 leads to the cargo hold 32 whereby the helicopter 20 can be driven up along the ramp 33 and into the cargo hold 32 by way of the aperture 34 during a loading operation. The cargo plane 30 may also include a track 35, which is disposed on the ramp 33 and in the cargo hold 32 to help guide the loading operation of the helicopter 20 into the cargo hold 32.

It will be understood that the various components of the helicopter 20 and the cargo plane 30 have irregular shapes and that the size of the aperture 34 may only be slightly larger than the helicopter 20. Indeed, in some cases, the aperture 34 may be sized differently than the helicopter 20. As such, the loading operation must follow certain processes and sub-operations to insure that the loading is conducted without the helicopter 20 impacting any components of the cargo plane 30.

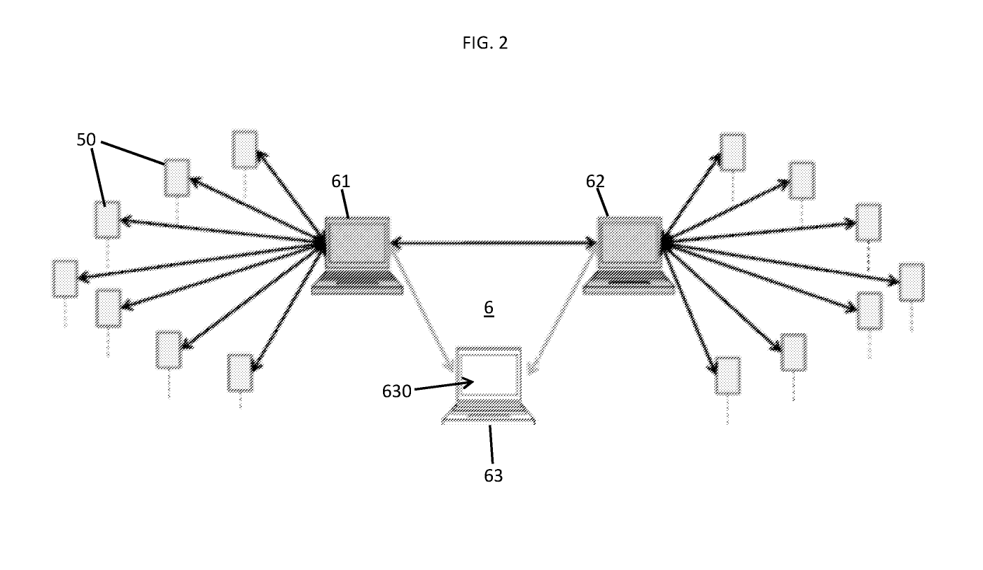

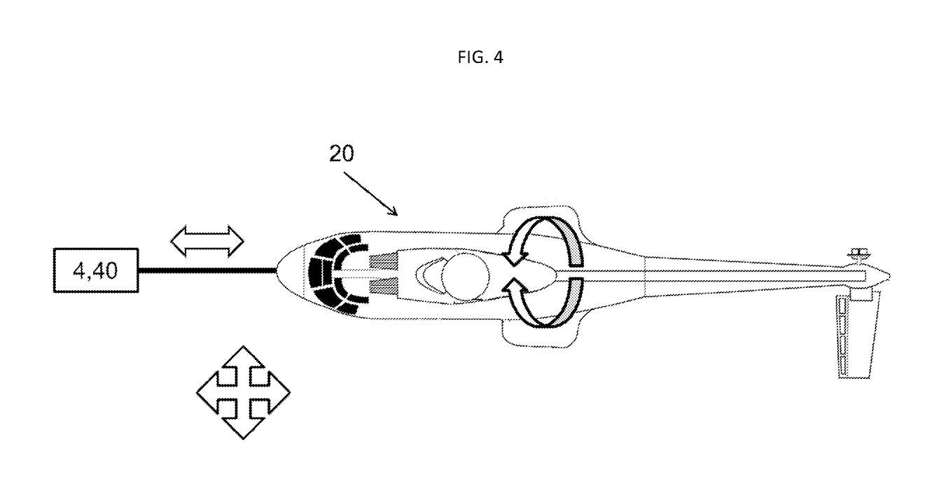

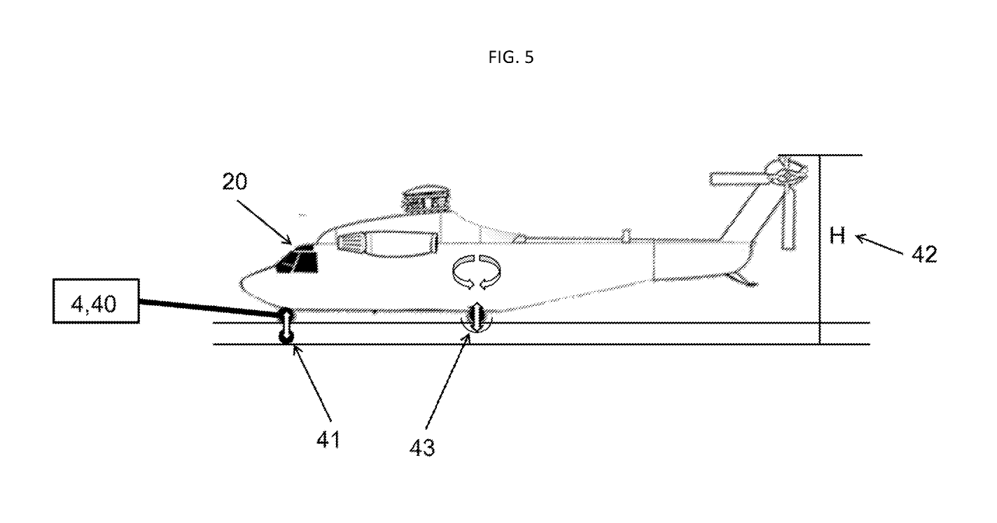

The clearance sensor system 1 thus includes an automatic or manually controlled driving element 4 (see FIGS. 4 and 5), a plurality of sensors 5 (FIG. 1) and a controller 6 (see FIG. 2). The driving element 4 is disposed to drive and manipulate (i.e., manually or automatically) the helicopter 20 relative to the cargo plane 30. The plurality of sensors 5 may include laser measurement sensors 50 (see FIG. 2) that are arrayed about at least the cargo plane 30 and possibly the helicopter 20 to generate real-time or quasi-dynamic readings of physical separation of the helicopter 20 and the cargo plane 30. The controller 6 is operably coupled to the driving element 4 and the plurality of sensors 5. The controller 6 is thereby configured to facilitate execution of real-time or quasi-dynamic control of a driving and a manipulation of the helicopter 20 by the driving element 4 in accordance with the readings of the physical separation between the helicopter 20 and the cargo plane 30 provided by the plurality of sensors 5. In some cases, the facilitation of the execution of the control may be achieved by the controller 6 directly operating the driving element 4 or by the controller 6 generating data that is usable by an operator of the driving element 4 to make decisions as to how to operate the driving element 4 and to judge results of the those decisions so as to improve future decision making. In accordance with embodiments, the controller 6 is configured to ascertain battery levels, capture settings, cross-talk, sensor orientations, etc.

With additional reference to FIGS. 4 and 5, the driving element 4 may be provided as aircraft support equipment 40, such as a winch, tug or another suitable device, which is disposed to drive and manipulate (i.e., manually or automatically) the helicopter 20 with multiple degrees of freedom. For example, as shown in FIG. 4, the equipment 40 in conjunction with the helicopter steering can drive the helicopter 20 forwardly to the right or left, reversely to the right or left or rotatably in either clockwise or counter-clockwise directions. Meanwhile, as shown in FIG. 5, the equipment 40 can drive the helicopter 20 upwardly, downwardly or pivotably to increase or decrease the helicopter 20 pitch position.

The helicopter 20 itself may further include manipulation features. For example, the helicopter 20 may include landing gear 41 that can be extended and retracted as well as tire components 43 that can be inflated or deflated to increase or decrease a helicopter 20 height and one or more blade components 42 of the main rotor 22 or the tail rotor 23 that be folded or unfolded to adjust an overall size of the helicopter 20.

As shown in FIG. 1, the plurality of sensors 5 includes individual sensors 51 that are arrayed at predetermined positions of at least the cargo plane 30 and possibly the helicopter 20. In either case, the individual sensors 51 may be disposed to face inwardly into the cargo hold 32 with some individual sensors 51 disposed to face downwardly from a roof of the cargo hold 32, some individual sensors 51 disposed to face upwardly from a floor of the cargo hold 32 and some individual sensors 51 disposed to face cross-wise from sidewalls of the cargo hold 32. In accordance with embodiments, one or more of the individual sensors 51 may be arrayed at portions of at least the second article 3 that are associated with tight clearance tolerances (see, e.g., sensor 510 in FIG. 1). That is, in the case of a C-17 loading operation, one or more of the individual sensors 51 may be placed at the wing box, the ramp 33 crest, the ramp 33 foot, the side of the frame of the aperture 34 and the rear of the frame of the aperture 34.

As shown in FIG. 2 and, in accordance with embodiments, the controller 6 may include at least a first sensor controller 61, a second sensor controller 62 and a third sensor controller 63. The first sensor controller 61 is disposed in wired or wireless signal communication with at least a first set of the plurality of sensors 5, the second sensor controller 62 is disposed in wired or wireless signal communication with a second set of plurality of sensors 5/50 and the third sensor controller 63 is disposed in wired or wireless signal communication with the first and second sensor controllers 61 and 62. With this configuration, the controller 6 can capture data from the plurality of sensors 5/50, import and align raw data, filter the raw data and, using developed models, evaluate the data.

For example, with the configuration described above, a user may receive and review raw and/or filtered data from the first set of the plurality of sensors 5 at the first or third sensor controllers 61 or 63 (or possibly, the second sensor controller 62 as well) and data from the second set of the plurality of sensors 5 at the second or third sensor controllers 62 or 63 (or possibly, the first sensor controller 61 as well).

In accordance with some embodiments, any one or more of the first, second and third sensor controllers 61, 62 and 63 may be configured to generate a user interface by which real-time, quasi-dynamic or post-processing review of data generated by the plurality of sensors 5 may be conducted. In such cases, the user interface can be operated from a laptop or a tablet device and may be a command prompt interface or a graphical user interface (GUI). The user interface may permit access to named files and displays raw data (time code, measurements, photo/video) compiled from the plurality of sensors 5. The interface may also allow a user to search for a particular individual sensor 51 for identification, calibration and notation (i.e., adding notes to the sensor data during continuous capture, such as when a person walks by or knocks over the sensor or when a major event occurs, so that corresponding data can be manually or automatically discarded) of the individual sensor 51. The user interface may also be capable of aligning photo/video capture with sensor data, facilitating “instant messaging” and integrating recorded voice communications between the first, second and third sensor controllers 61, 62 and 63, sending notifications that minimum clearances are violated (i.e., so that the load can be stopped) and controlling the plurality of sensors 5 during immediate capture and continuous capture operations. For example, the user interface may be able to ping single or multiple sensors to control the plurality of sensors 5 to take immediate captures, to have varied times between immediate captures, to institute buffer timing, to change laser aiming and to determine battery and power status.

In accordance with further embodiments, the controller 6 may include a computer readable medium having instructions stored thereon, which, when executed, cause the controller 6 to facilitate or otherwise adjust the execution of the real-time or quasi-dynamic control of the driving and the manipulation of the helicopter 20 in accordance with a most-recent set of the readings of the plurality of sensors 5, to develop a model for facilitating an execution of the real-time or quasi-dynamic control of the driving and the manipulation for respective pairs of multiple helicopters 20 and cargo planes 30, to store or export data relating to the executing of the real-time control of the driving and the manipulating and to generate and display a user interface 630 enabling user input for executing the real-time or quasi-dynamic control of the driving and the manipulating.

Regarding the model development embodiment, the controller 6 may be configured to record a particular loading operation of the helicopter 20 relative to the cargo plane 30 and to recognize that the loading operation is successful if no impacts or undesirable deviations from a desired track for the helicopter occur. In such a case, the controller 60 may recognize success automatically or be receptive of a manual input by a user that the loading operation was successful. In any case, the recorded loading operation may then be employed as a model for future loading operations of a same (or similar) type of helicopter 20 relative to a same (or similar) type of cargo plane 30. Thus, during the future loading operations, the prior path and event sequence taken by the helicopter 20 can be referred to as a target path and a target sequence and any deviations from that target path and target sequence can be easily corrected in real-time.

In accordance with embodiments, the target path may be defined as the forward, reverse, upward, downward, steering or pivoting path taken by the helicopter 20 during a given loading operation. Meanwhile, the target sequence may refer to various sub-operations, such as tire inflation or deflation, taken by the driving element 4 during the loading operation to manipulate the helicopter 20 into assuming a given size or position. In accordance with further embodiments, the model can be refined over the course of the loading operation and subsequent loading operations to improve loading speed or to reduce the number of path changes or sequential events. Such refinements may reduce loading times, loading energy costs, man power, required helicopter disassembly, etc.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A clearance sensor system for use in moving first and second articles relative to each other, the clearance sensor system comprising:
an automatic or manually controlled driving element disposed to drive and manipulate the first article relative to the second article;
a plurality of sensors arrayed about at least the second article to generate real-time readings of a position of the first article relative to the second article; and
a controller operably coupled to the driving element and the plurality of sensors, the controller being configured to facilitate:
an execution of real-time or quasi-dynamic control of a driving and a manipulation of the first article by the driving element in accordance with the readings of the physical separation between the first and second articles provided by the plurality of sensors, and
a post-processing of data relating to the real-time or quasi-dynamic control of the driving and the manipulation of the first article by the driving element.

2. The clearance sensor system according to claim 1, wherein the first article comprises at least a helicopter and the second article comprises at least a cargo plane.

3. The clearance sensor system according to claim 1, wherein the driving element is disposed to drive and manipulate the first article with multiple degrees of freedom.

4. The clearance sensor system according to claim 1, wherein the plurality of sensors comprises a plurality of measurement sensors.

5. The clearance sensor system according to claim 1, wherein the plurality of sensors comprises sensors arrayed at predetermined positions of at least the second article.

6. The clearance sensor system according to claim 1, wherein the plurality of sensors comprises sensors arrayed at portions of at least the second article associated with tight clearance tolerances.

7. The clearance sensor system according to claim 1, wherein the controller comprises any one or more of:
a first sensor controller disposed in signal communication with a first set of the plurality of sensors;
a second sensor controller disposed in signal communication with a second set of the plurality of sensors; and
a third sensor controller disposed in signal communication with the first and second sensor controllers.

8. The clearance sensor system according to claim 1, wherein the controller comprises a computer readable medium having instructions stored thereon, which, when executed, cause the controller to store or export data relating to the executing of the real-time or quasi-dynamic control of the driving and the manipulation.

9. The clearance sensor system according to claim 1, wherein the controller is further configured to generate and display a user interface enabling user input for executing the real-time or quasi-dynamic control of the driving and the manipulation.

10. A controllable clearance sensor system for use in moving first and second articles relative to each other, the controllable clearance sensor system comprising:
an automatic or manually controlled driving element disposed to drive and manipulate the first article relative to the second article;
a plurality of sensors arrayed about at least the second article to generate real-time readings of a position of the first article relative to the second article; and
a controller operably coupled to the driving element and comprising multiple sensor controllers disposed in signal communication with each other and with respective sets of the plurality of sensors,
the controller being configured to facilitate an execution of real-time or quasi-dynamic control of a driving and a manipulation of the first article by the driving element in accordance with user input and the readings of the physical separation between the first and second articles provided by the plurality of sensors.

11. The controllable clearance sensor system according to claim 10, wherein the controller comprises a computer readable medium having instructions stored thereon, which, when executed, cause the controller to facilitate an adjustment of the execution of the real-time or quasi-dynamic control of the driving and the manipulation in accordance with a most-recent set of the readings.

12. The controllable clearance sensor system according to claim 10, wherein the controller comprises a computer readable medium having instructions stored thereon, which, when executed, cause the controller to import raw data, extract accurate data while expelling erroneous data, align the accurate data to a configured model, filter the aligned data for operator use and permit evaluation.
